(19) United States
(12) Patent Application Publication
(10) Pub. No.: US 2024/0419778 A1
(43) Pub. Date: Dec. 19, 2024

(54) COMPUTER GENERATED PASSWORD CRITERIA COMBINATIONS

(71) Applicant: International Business Machines Corporation, Armonk, NY (US)

(72) Inventors: Johnny Shieh, Austin, TX (US); Jessica Murillo, Round Rock, TX (US); Kelley Anders, East New Market, MD (US)

(21) Appl. No.: 18/334,688

(22) Filed: Jun. 14, 2023

(51) Int. Cl. G06F 21/46

(52) U.S. Cl. CPC G06F 21/46

(57) ABSTRACT

Computer generated password criteria generated in response to a required password change can include detecting a request for a new password for a program. A password criteria for the new password is generated, which is different than a previous password criteria. A submitted new password is received and a determination is made when the submitted new password meets each of the password criteria for the new password. Responsive to determining the submitted new password meets each of the password criteria for the new password, access is allowed to the program.

### BACKGROUND

The present invention relates generally to the field of computer automated password suggestions.

An electronic password, sometimes called a passcode is a secret data entry, typically a string of characters, digits, or other symbols used to confirm a user's identity. For verifying passwords, the secret is held by a party called the claimant while the party verifying the identity of the claimant is called the verifier. When the claimant successfully demonstrates knowledge of the password to the verifier through an established authentication protocol, for example by inputting the electronic password using a computer system or smart device, the verifier is able to infer or verify the claimant's identity. When a claimant's identity is verified, the computer, account, or any locked item, material, or data, is unlocked and the claimant is electronic granted access.

### SUMMARY

In one embodiment according to the invention, techniques are disclosed for computer automated suggestions of password criteria combination.

According to one embodiment of the present invention, a computer-implemented method for generating a password criteria combination in response to a required password change is disclosed. The computer-implemented method includes detecting, by a computer, a request for a new password for a program. The computer-implemented method further includes generating, by the computer, a password criteria for the new password, the password criteria being different than a previous password criteria. The computer-implemented method further includes receiving, at a computer, a submitted new password from a user device. The computer-implemented method further includes determining, by the computer, the submitted new password meets each of the password criteria for the new password. The computer-implemented method further includes allowing, by the computer, access to the program.

According to another embodiment of the present invention, a computer program product for generating a password criteria combination in response to a required password change is disclosed. The computer program product includes one or more computer readable storage media and program instructions stored on the one or more computer readable storage media. The program instructions include instructions to detect a request for a new password for a program. The program instructions further include instructions to generate a password criteria for the new password, the password criteria being different than a previous password criteria. The program instructions further include instructions to receive a submitted new password from a user device. The program instructions further include instructions to determine the submitted new password meets each of the password criteria for the new password. The program instructions further include instructions to allow access to the program.

According to another embodiment of the present invention, a computer system for generating a password criteria combination in response to a required password change is disclosed. The computer system includes one or more computer processors, one or more computer readable storage media, and computer program instructions, the computer program instructions being stored on the one or more computer readable storage media for execution by the one or more computer processors. The program instructions include instructions to detect a request for a new password for a program. The program instructions further include instructions to generate a password criteria for the new password, the password criteria being different than a previous password criteria. The program instructions further include instructions to receive a submitted new password from a user device. The program instructions further include instructions to determine the submitted new password meets each of the password criteria for the new password. The program instructions further include instructions to allow access to the program.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of computing environment, suitable for the execution of at least some of the computer code involved in performing the inventive methods, in accordance with at least one embodiment of the present invention.

FIG. 2 is a flow chart diagram depicting operational steps for password requirement system, in accordance with at least one embodiment of the present invention.

FIG. 3 is a flow chart diagram depicting operational steps for password requirement system, in accordance with at least one embodiment of the present invention.

FIG. 4 is a functional block diagram depicting a password requirement system, in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Most computer or accounts require users to change their password based on a time cycle or some seminal event, such as a computer system breach. When changing a password, the minimum requirements of the password are given to the user and the user picks a new password that will fit those requirements. Embodiments of the present invention recognize many devices or platforms with accounts require passwords to be changed based on a time cycle or seminal event, such as a security computer system breach or forgotten password. Currently, the password requirements are the same every time a user selects a new password for a particular account or device. Embodiments of the present invention recognize by listing the minimal requirements for an acceptable password, the security rules provide a guideline for potential hackers and unauthorized parties on password combinations to not attempt. Meaning, if a password requirement is the same number cannot be used three times in a row, a potential hacker knows the password does not contain the same number three times in a row. Since minimum password requirements do not vary between time cycles, this gives unauthorized parties a longer length of time, with known password exceptions, to try methods with potential password combinations to access user accounts.

Embodiments of the present invention select password requirements from a list of password requirements to create a unique combination of password requirements for a password. This way, a potential hacker is not put on notice of the password requirement since each password will satisfy a different set or combination of password requirements. Meaning, there is a lower chance of a potential hacking being able to guess or predict someone else's password without knowing the password requirements used to make the password. For example, embodiments of the present invention generate N-list of different types of acceptable password rules. When the user's account or device requires a new password after M-weeks of use of the old password, one or more of the N-rules are selected as the basis for acceptance of the new password. Embodiments of the present invention are advantageous for changing the minimal requirement rules which reduce the change of an unauthorized party gaining access to a users account or device. With changing minimal requirement rules, unauthorized parties may have already excluded possible password combinations based on an old set of rules and must now re-tool their hacking combinatorial generator for a new set of rules. However, an unauthorized party cannot be sure which of the N-list of password rules they must re-tool to match, further reducing the chances of brute force break into a user's account. Embodiments of the present invention recognize password rule rotation reduces the changes for users to re-use previously used passwords or have new passwords similar to previously used passwords.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

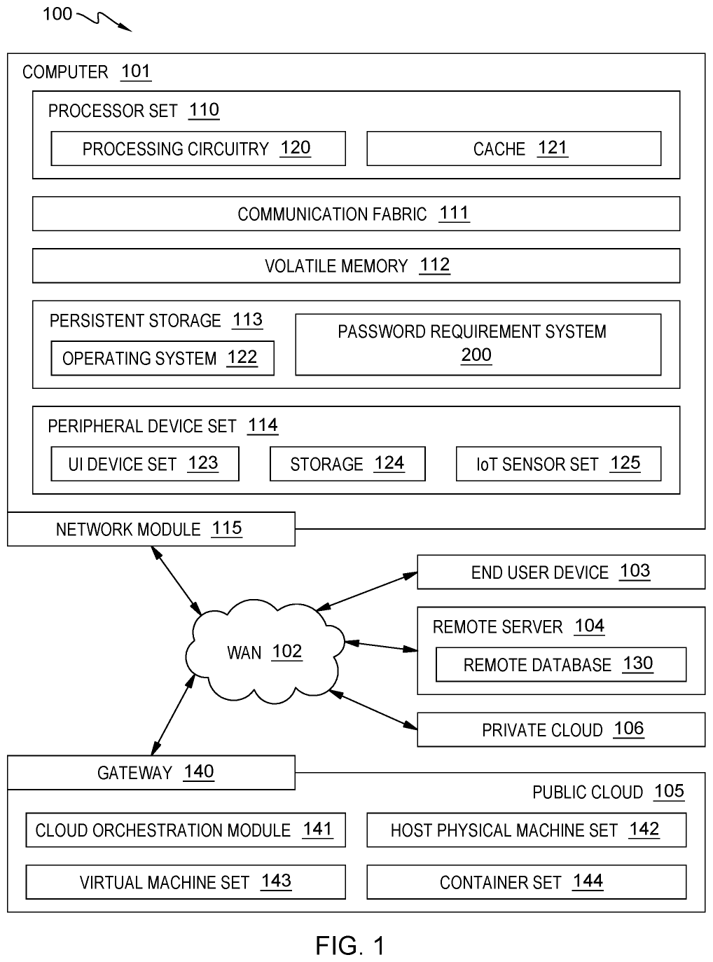

The present invention will now be described in detail with reference to the Figures. FIG. 1 is a functional block diagram of computing environment, generally designated 100, suitable for the execution of at least some of the computer code involved in performing the inventive methods, such as new password requirement code, in accordance with at least one embodiment of the present invention. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in a password requirement system typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. n embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In an embodiment, a database may include personal data, content, contextual data, or information related to a user. Consent for accessing and storing such personal data can include opt-in consent which can impose on the user taking an action, that is, authorizing access and storage of data, before personal data is processed. Alternatively, opt-out consent can impose on the user to take an action to prevent the processing of personal data before personal data is processed. In an embodiment, confidential communication system provides information regarding personal data and the nature (e.g., type, scope, purpose, duration, etc.) of the processing. In an embodiment, confidential communication system provides a user with copies of stored personal data. In an embodiment, speech confidential communication system allows for the correction or completion of incorrect or incomplete personal data. In an embodiment, confidential communication system allows for the immediate deletion of personal data. In an embodiment, confidential communication system provides informed consent, with notice of configuring microphone settings, network connections, and device power and requires opt-in consent before altering any microphone settings, network connections, and device power. Alternatively, opt-out consent can impose on the user to take an affirmative action to prevent configuring microphone settings, network connections, and device power. In an embodiment, password requirement system provides notice and receives informed consent to access, access, update, and change passwords.

In an embodiment, password requirement system 200 is represented by new password requirement code. In an embodiment, password requirement system stores past, current, or changed passwords in a database. In some embodiments, password requirement system stores a list of user accounts respectively associated with a password. In some embodiments, password requirement system further stores a password's expiration.

Password requirement system determines if a new password is required. In an embodiment, the password is for a program, application, device, or any password required to access something digitally. In some embodiments, a new password change is required after a predetermined amount of time has passed since the last or previous password was created. For example, a password needs to be changed every 90 days. In some embodiments, a new password change is required after a predetermined number of log ins. For example, a password needs to be changed after used to successfully log in 100 times. In some embodiments, a new password change is required after a predetermined number of unsuccessful log ins or log in attempts. An unsuccessful log in or log in attempt can include when a wrong password is received for a particular username or log in combination. For example, a password needs to be changed after an incorrect password and username combination is received more than 5 times in a row. In some embodiments, password requirement system receives user input a new password is required. For example, password requirement system receives user input user selected “forgot password” option on a user interface.

In an embodiment, password requirement system generates a set or list of different types of password requirements or criteria. A password requirement or criteria can include any limitation, rule, or constraint for the password. For example, the password requirements or criteria can includes a limitation on any letters, numbers, asterisk, words, special characters, symbols, accent marks, punctuation marks, grammar, or phrases used in a password. A special character can be any character that is not an alphabetic or numeric character. A password requirement can include a limitation such as the password must contain at least one uppercase letter and two lower case letters. In another example, a password requirement or criteria can include a limitation such as the password cannot have the same letter or number more than three times in a row, such as the “3's” in “Password333”. A password requirement or criteria can further include a predetermined threshold on the length of the password. For example, the password must be at least 10 characters in length.

In an embodiment, password requirement system generates a password criteria list. A password criteria list includes one or more password requirements for the new password. In an embodiment, the password rule list is generated by password requirement system generating a random subset of different types of password criteria rules. For example, password requirement system selects one or more password criteria from the set or list of different types of password requirement rules. Further, password requirement system selects three password criteria from the list of different types of password requirement rules or criteria. In this example, password requirement system selects three password requirements which include (i) new password cannot match any previously used passwords; (ii) must contain at least 8 characters; and (iii) must contain at least one special character (e.g., ˜! @ #$ % \hat{ }&*?).

In an embodiment, password requirement system displays the password rule list or criteria including the one or more password requirements or criteria, to the user. In an embodiment, password requirement system receives a new or changed password. Password requirement system determines if the new password meets the password criteria. For example, if one of the password criteria in the random subset of different types of password criteria included “minimum of 2 capital letters” a new password of “PassWord123?” would meet the requirement of including a minimum of 2 capital letters because the letters “P” and “W” are capitalized. In an embodiment, if the new password does not meet one or more of the password criteria, password requirement system does not accept the new password and request the user to attempt another new password until a new password meets every password requirement. For example, if the password requirements in the random subset of different types of password requirements included two requirements of “minimum of 2 capital letters” and “at least one number” a new password of “PassWord” would meet the requirement of 2 capital letters but would not meet the requirement of having at least one number. In this instance, password requirement system does not accept the new password and request user to attempt another new password containing at least one number.

Although password requirement system selects password criteria combination at random to generate a random subset of the different types of password criteria, it is possible a rule set is identical to a previous rule set. In some embodiments, password requirement system requires the last subset of different types of password criteria to not be identical to the new random subset of different types of password criteria. However, some criteria can be identical to a previous criteria, in some embodiments, not all the criteria can be identical to a previous criteria. For example if a previous password criteria was: (i) minimum 2 numbers; and (ii) minimum 8 letters, a new password criteria could be: (i) at least one capital letter; and (ii) minimum 8 letters. Here, only one previous criterion matches, meaning the previous password criteria is not identical to the new password criteria.

In some embodiments, password requirement system requires a predetermined amount of users within a platform, application, or similar, to have different subsets of the different types of password criteria. For example, password requirement system requires more than half of the user accounts for a program have different subsets of the different types of password criteria.

Password requirement system accepts the new or changed password if it satisfies each password criteria. In some embodiments, password requirement system updates the password respective to an account or device or other login information. In an embodiment, if the new password satisfies each password criteria, password requirement system allows access to the program.

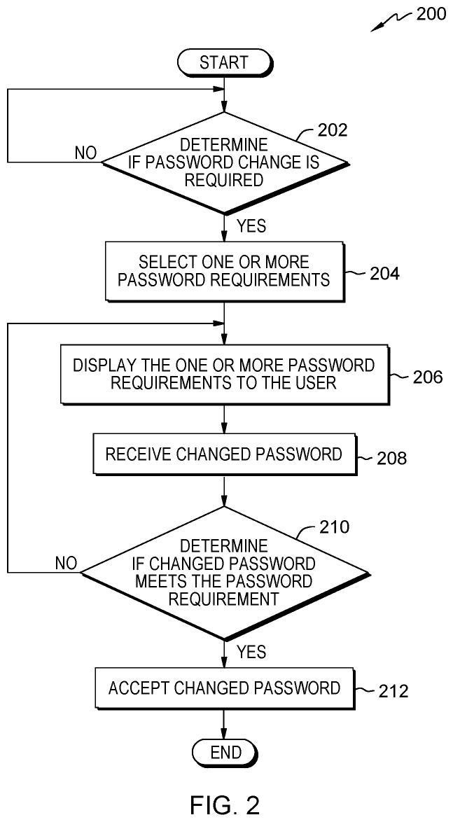

Referring to FIG. 2, a password requirement system 200, in accordance with at least one embodiment of the present invention includes an implementation of the present disclosure and does not imply any limitations with regard to the environments in which different embodiments may be implemented. Many modifications to the depicted environment may be made by those skilled in the art without departing from the scope of the invention as recited by the claims.

The password requirement system 200 determines if a password change is required, as shown in block 202.

The password requirement system 200 selects one or more password requirements, as shown in block 204. In an embodiment, password requirement system 200 selects one or more password requirements based on a selected policy.

In an embodiment, password requirement system 200 displays the one or more password requirements to the user, as shown in block 206.

In an embodiment, password requirement system 200 receives changed password, as shown in block 208.

In an embodiment, password requirement system 200 determines if the changed password meets the password requirements, as shown in block 210. In an embodiment, password requirement system determines the changed password meets the password requirements if the changed password satisfies all the password requirements.

In an embodiment, password requirement system 200 accepts the changed password, as shown in block 212.

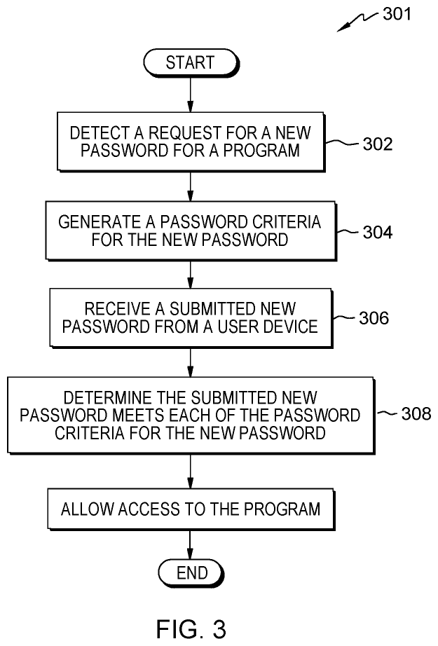

Referring to FIG. 3, a password requirement system 301, in accordance with at least one embodiment of the present invention includes an implementation of the present disclosure and does not imply any limitations with regard to the environments in which different embodiments may be implemented. Many modifications to the depicted environment may be made by those skilled in the art without departing from the scope of the invention as recited by the claims.

The password requirement system 301 detects a request for a new password for a program, as shown in block 302. A program can include a device program, application program, or any electronic program requiring a password to gain access to a program or platform. For example, a password to unlock a phone. In some embodiments, password requirement system 301 detects a request for a new password for a program by receiving user input or input from the program as a request for a new password. In some embodiments, password requirement system 301 detects a request for a new password for a program when a predetermined amount of time has passed since the password was updated, created, or changed. In some embodiments, password requirement system 301 detects a request for a new password for a program after a predetermined number of unsuccessful logins to the program.

In an embodiment, password requirement system 301 generates a password criteria for the new password, as shown in block 304. For example, the password criteria includes a list of a plurality of password requirements. In an embodiment, more than half of user accounts for a particular program have different password criteria. In an embodiment, at least one of the password criteria options is a limitation on any letters, numbers, asterisk, words, special characters, symbols, accent marks, punctuation marks, grammar, or phrases used in the changed password. In an embodiment, the generated password criteria is not identical to a previous password criteria. In some embodiments, password requirement system generates a password criteria by selecting one or more password requirements at random from a list of password criteria. In an embodiment, password requirement system categorizes the password criteria in one or more types of password criteria. In some embodiments, password requirement system further generates the password criteria based, at least in part, on selecting at least two criteria from two different types of password criteria.

In an embodiment, password requirement system 301 receives a submitted new password from a user device, as shown in block 306.

In an embodiment, password requirement system 301 determines the submitted new password meets each of the password criteria for the new password, as shown in block 308.

In an embodiment, password requirement system 301 allows access to the program, as shown in block 310.

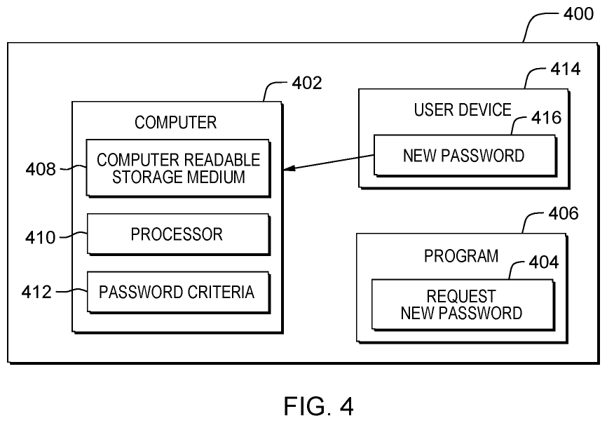

FIG. 4 is a functional block diagram for password requirement system, in accordance with at least one embodiment of the present invention. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

As depicted in FIG. 4, environment 400, includes a network connected to computer 402, device 414, and a password database. In an embodiment, computer 402, device 414, and the password database are connected. In an embodiment, computer 402, device 414, and the password database are combined as one singular or two devices.

As depicted, computer 402 includes computer readable storage medium 408, processor 410, set of different types of password requirements 412, and random subset of different type of password requirements for respective a password expiration. Further as depicted, a password database can include a list of user accounts respectively associated with a password and a password expiration.

In an example, password requirement system determines a password expiration. A password expiration can include a password, account, or device which includes an expired password. A password which is expired requires a new or changed password 404. Password requirement system determines a set of different types of password requirements 412. From the set of different types of password requirements, password requirement program 406 determines a random subset of different type of password requirements for respective password expiration. Password requirement system receives a changed password 416 from device 414. Password requirement system further determines if the changed password 416 meets the password requirements in random subset of different type of password requirements for a respective password expiration. If the changed password 416 abides by the password requirements in random subset of different type of password requirements for respective password expiration, password requirement system accepts the changed password and updates the list of user accounts respectively associated with a password.

What is claimed is:

1. A computer-implemented method for generating a password criteria combination in response to a required password change, the computer-implemented method comprising:
detecting, by a computer, a request for a new password for a program;
generating, by the computer, password criteria for the new password, the password criteria being different than a previous password criteria;
receiving, at the computer, a submitted new password;
determining, by the computer, when the submitted new password meets each of the password criteria for the new password; and
allowing, by the computer, access to the program.

2. The computer-implemented method of claim 1, wherein more than half of user accounts for the program have different password criteria.

3. The computer-implemented method of claim 1, wherein detecting the request for a new password is based at least in part on, a predetermined amount of time passed since a previous password was created.

4. The computer-implemented method of claim 1, wherein the at least one of the password criteria options is a limitation on any letters, numbers, asterisk, words, special characters, symbols, accent marks, punctuation marks, grammar, or phrases used in the changed password.

5. The computer-implemented method of claim 1, wherein the password criteria is not identical to a previous password criteria.

6. The computer-implemented method of claim 1, wherein generating the password criteria further comprises:
selecting one or more password requirements at random from a list of password criteria.

7. The computer-implemented method of claim 1, wherein determining the request for a new password is based at least in part on, determining a predetermined number of unsuccessful log ins exceeds a predetermined threshold.

8. The computer-implemented method of claim 1, wherein generating the password criteria, further comprises categorizing the criteria in one or more types of password criteria and further generating the plurality of password criteria based, at least in part, on selecting at least two criteria from two different types of password criteria.

9. A computer program product for requiring a password change with a password criteria combination, the computer program product comprising one or more computer readable storage media and program instructions stored on the one or more computer readable storage media, the program instructions including instructions to:
detect a request for a new password for a program;
generate password criteria for the new password, the password criteria being different than a previous password criteria;
receive a submitted new password from a user device;
determine the submitted new password meets each of the password criteria for the new password; and
allow access to the program.

10. The computer program product of claim 9, wherein more than half of user accounts for the program have different password criteria.

11. The computer program product of claim 9, wherein the instructions to detect the request for a new password is based at least in part on, a predetermined amount of time passed since a previous password was created.

12. The computer program product of claim 9, wherein the at least one of the password criteria options is a limitation on any letters, numbers, asterisk, words, special characters, symbols, accent marks, punctuation marks, grammar, or phrases used in the changed password.

13. The computer program product of claim 9, wherein the password criteria is not identical to a previous password criteria.

14. The computer program product of claim 9, wherein generating the password criteria further comprises instructions to:
select one or more password requirements at random from a list of password criteria.

15. The computer program product of claim 9, wherein the instructions to determine the request for a new password is based at least in part on, instructions to determine a predetermined number of unsuccessful log ins exceeds a predetermined threshold.

16. The computer program product of claim 9, wherein the instructions to generate the password criteria, further comprises instructions to categorize the criteria in one or more types of password criteria and further generating the plurality of password criteria based, at least in part, on selecting at least two criteria from two different types of password criteria.

17. A computer system for requiring a password change with a password criteria combination, comprising:
one or more computer processors;
one or more computer readable storage media;
computer program instructions;
the computer program instructions being stored on the one or more computer readable storage media for execution by the one or more computer processors; and
the computer program instructions including instructions to:
detect a request for a new password for a program;
generate password criteria for the new password, the password criteria being different than a previous password criteria;
receive a submitted new password from a user device;
determine the submitted new password meets each of the password criteria for the new password; and
allow access to the program.

18. The computer system of claim 17, wherein more than half of user accounts for the program have different password criteria.

19. The computer system of claim 17, wherein the password criteria is not identical to a previous password criteria.

20. The computer system of claim 17, wherein the instructions to detect the request for a new password is based at least in part on, a predetermined amount of time passed since a previous password was created.
